(19) United States
(12) Patent Application Publication
(10) Pub. No.: US 2021/0070301 A1
(43) Pub. Date: Mar. 11, 2021

(54) PARTIALLY-AUTONOMOUS ROAD VEHICLE CONTROL VIA A SINGLE-EXTREMITY INTERFACE

(71) Applicant: Toyota Motor Engineering & Manufacturing North America, Inc., Erlanger, KY (US)

(72) Inventors: Vladimeros Vladimerou, Whitmore Lake, MI (US); Miles J. Johnson, Ann Arbor, MI (US)

(73) Assignee: Toyota Motor Engineering & Manufacturing North America, Inc., Erlanger, KY (US)

(21) Appl. No.: 16/567,785

(22) Filed: Sep. 11, 2019

(51) Int. Cl. B60W 30/18; B60W 30/06; B60W 50/10; G05D 1/00

(52) U.S. Cl. CPC B60W 30/18163; B60W 30/06; B60W 50/10; G05D 2201/0213; B60W 2540/10; B60W 2720/10; G05D 1/0088

(57) ABSTRACT

Methods and systems may provide for technology to control a road vehicle in a partially-autonomous mode along a default path and change a speed of the road vehicle in response to a first actuation event. The technology may also automatically deviate the road vehicle from a current lane on the default path in response to a second actuation event if a distance condition is satisfied with response to one or more of a future lane change or a future turn on the default path, wherein the first actuation event and the second actuation event are associated with a single-extremity user operation.

### TECHNICAL FIELD

Embodiments generally relate to vehicle controls. More particularly, embodiments relate to partially-autonomous road vehicle control via a single-extremity interface.

### BACKGROUND

The operation of road vehicles by physically-disabled individuals is typically made more challenging by the complexities of vehicle control (e.g., simultaneous changes in direction and speed) coupled with safety concerns (e.g., risks to the driver, pedestrians and/or other drivers). While fully-autonomous vehicles may use advanced sensing and artificial intelligence (AI) technology to address vehicle control complexities, there remains considerable room for improvement with regard to safety. For example, there may continue to be unforeseen conditions during operation that are not readily identifiable by AI technology without appropriate neural network training.

### BRIEF SUMMARY

In one embodiment, a vehicle control system comprises a sensor to determine a speed of a road vehicle, a processor coupled to the sensor, and a memory coupled to the processor, the memory comprising a stored default path and a stored set of instructions, which when executed by the processor, cause the vehicle control system to control the road vehicle in a partially-autonomous mode along the default path, change the speed of the road vehicle in response to a first actuation event, and deviate the road vehicle from a current lane on the default path in response to a second actuation event if a distance condition is satisfied with respect to one or more of a future lane change or a future turn on the default path, wherein the first actuation event and the second actuation event are associated with a single-extremity user operation. In an embodiment, single-extremity actuation events can also include a rapid sequence of user inputs (e.g., repeated button/pedal presses).

In another embodiment, at least one computer readable storage medium comprises a set of instructions, which when executed by a computing system, cause the computing system to control a road vehicle in a partially-autonomous mode along a default path, change a speed of the road vehicle in response to a first actuation event, and deviate the road vehicle from a current lane on the default path in response to a second actuation event if a distance condition is satisfied with respect to one or more of a future lane change or a future turn on the default path, wherein the first actuation event and the second actuation event are associated with a single-extremity user operation.

In yet another embodiment, a method of operating vehicle control system comprises controlling a road vehicle in a partially-autonomous mode along a default path, changing a speed of the road vehicle in response to a first actuation event, and automatically deviating the road vehicle from a current lane on the default path in response to a second actuation event if a distance condition is satisfied with respect to one or more of a future lane change or a future turn on the default path, wherein the first actuation event and the second actuation event are associated with a single-extremity user operation.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is an illustration of an example of single-extremity user interfaces according to embodiments;

FIG. 2 is a flowchart of an example of a method of operating a vehicle control system according to an embodiment;

FIG. 3 is a flowchart of an example of a method of parking a partially-autonomous road vehicle according to an embodiment;

FIG. 4 is a flowchart of an example of a method of selectively activating a partially-autonomous mode according to an embodiment;

FIG. 5 is a flowchart of an example of a method of managing the progress of a partially-autonomous road vehicle according to an embodiment;

FIG. 6 is a flowchart of an example of a method of deviating a road vehicle from a current lane on a default path according to an embodiment;

FIG. 7 is a block diagram of an example of a vehicle control system according to an embodiment; and

FIG. 8 is a state diagram of an example of a vehicle control system according to an embodiment.

### DETAILED DESCRIPTION

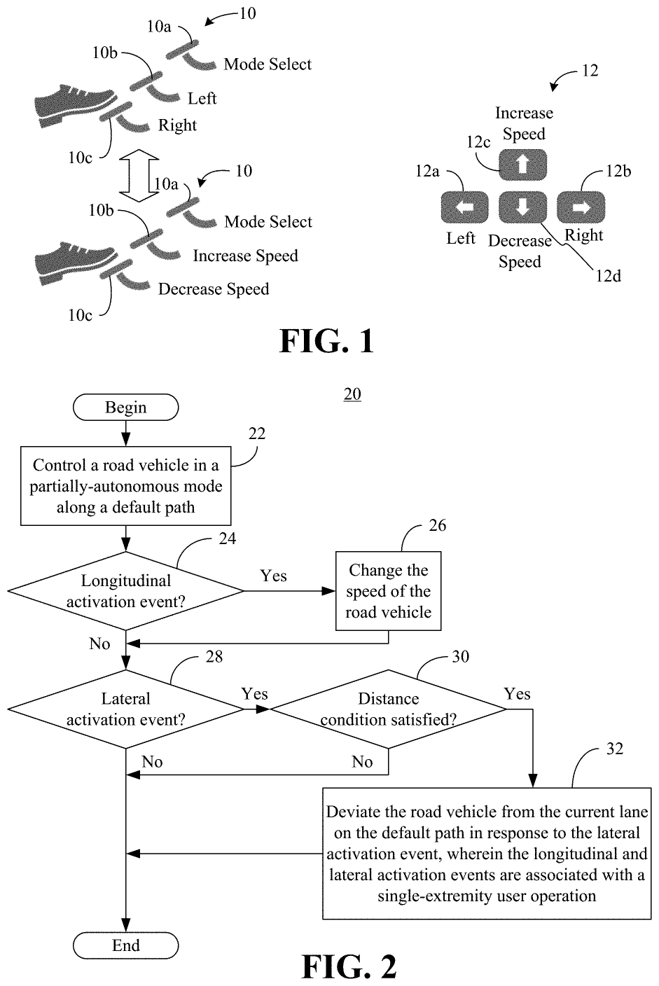

Turning now to FIG. 1, examples of single-extremity interfaces are shown in which a physically-disabled individual may operate a road vehicle in a partially-autonomous mode. In one example, a set of foot pedals 10 (10a-10c) enable a single-foot operation to conduct both direction changes and speed changes. More particularly, stepping on a first pedal 10a might toggle the vehicle control between a manual (e.g., driver-controlled) direction mode and a manual speed mode. In the manual direction mode, stepping on a second pedal 10b controls steering to the left and stepping on a third pedal 10c controls steering to the right. In the manual speed mode, stepping on the second pedal 10b controls speed increases (e.g., acceleration) and stepping on the third pedal 10c controls speed decreases (e.g., braking, deceleration). Continuous pedal pressure may also be preprocessed into a discrete signal. In this case, an actuation event may include rapid repeated pedal presses. Thus, the same foot (e.g., a single extremity) controls both direction changes and speed changes, in the illustrated example.

In another example, a set of arrow keys 12 (12a-12d, e.g., on a keyboard and/or key pad) enable a single-finger operation to conduct both direction changes and speed changes. More particularly, pressing a first arrow key 12a controls steering to the left and pressing a second arrow key 12b controls steering to the right. Additionally, pressing a third arrow key 12c controls speed increases (e.g., acceleration) and pressing a fourth arrow key 12d controls speed decreases (e.g., braking, deceleration). Actuation events may also include a sequence of rapid key presses that modulate the response of the system (e.g., maneuver selection). Thus, the same finger (e.g., a single extremity) controls both direction changes and speed changes, in the illustrated example. Other single-extremity interfaces such as, for example, a joystick that enables single-hand operations, a microphone that enables vocal operations, etc., may also be used.

Of particular note is that while the road vehicle is in the manual speed mode, the direction of the vehicle may be automatically controlled (e.g., in a partially-autonomous mode) in accordance with a default path that is previously navigated/mapped and programmed into the road vehicle. The default path may generally include specified turns, exits, lane changes, etc., to navigate from a starting location to a destination location. Similarly, while the road vehicle is in the manual direction mode, the speed of the vehicle may be automatically controlled (e.g., adaptive cruise control/ACC) in accordance with the default path (e.g., taking into consideration speed limits, real-time traffic conditions and/or a predetermined pace).

Accordingly, the illustrated foot pedals 10 and/or arrow keys 12 enable the individual driving the road vehicle to make speed and direction adjustments in reaction to unforeseen conditions (e.g., cyclists traveling the wrong way in traffic) that are not part of the default path or readily identifiable by fully-autonomous driving (e.g., AI) solutions. As a result, safety is enhanced while enabling the physically-disabled individual to operate the road vehicle with an improved user experience. The illustrated single-extremity interfaces may also be used by non-disabled individuals (e.g., drivers wishing to take a break from fully-manual operation of the road vehicle).

FIG. 2 shows a method 20 of operating a vehicle control system. The method 20 may be implemented in logic instructions (e.g., software), configurable logic, fixed-functionality hardware logic, etc., or any combination thereof. Illustrated processing block 22 controls a road vehicle in a partially-autonomous mode along a default path. As already noted, the default path may include specified turns, exits, lane changes, etc., that are previously navigated/mapped and programmed into the road vehicle. Moreover, the default path may be automatically selected based on a number of factors such as, for example, the current time of day, the starting location, environmental factors (e.g., weather, traffic), frequency of use, the current path, etc., or any combination thereof. In an embodiment, block 22 includes automatically controlling the direction (e.g., steering along road curvatures, making turns and/or making lane changes) and/or speed of the road vehicle to remain on the default path. In an embodiment, block 22 also includes automatically activating one or more turn signals of the road vehicle in accordance with the default path.

A determination may be made at block 24 as to whether a longitudinal activation event (e.g., speed change) has been detected via a single-extremity interface such as, for example, the foot pedals 10 (FIG. 1) or the arrow keys 12 (FIG. 1). If so, block 26 automatically changes the speed of the road vehicle in accordance with the longitudinal activation event. Thus, block 26 may include applying breaks to decrease speed, opening the throttle to increase speed, and so forth.

Illustrated block 28 provides for determining whether a lateral activation event (e.g., direction and/or lane change) has been detected via the single-extremity interface. If so, a determination is made at block 30 as to whether a distance condition is satisfied with respect to one or more of a future lane change or a future turn on the default path. Thus, block 30 might involve identifying the next lane change (e.g., a move of one lane to the right in anticipation of a right turn) on the default path and comparing the next lane change to the requested lane change. If, for example, the requested lane change is a move of one lane to the left (e.g., to pass a slower vehicle) and the next lane change to the right is relatively close (e.g., fifty meters), block 30 might determine that the distance condition is not satisfied. By contrast, if the next lane change is relatively far (e.g., fifty kilometers), block 30 may determine that the distance condition is satisfied. If the distance condition is satisfied, block 32 automatically deviates the road vehicle from the current lane on the default path in response to the lateral activation event. In an embodiment, block 32 includes automatically activating one or more turn signals of the road vehicle in accordance with the deviation. If the distance condition is not satisfied, the method 20 bypasses block 32 and terminates.

In the illustrated example, the longitudinal activation event and the lateral activation event are associated with a single-extremity user operation. The illustrated method 20 therefore enables the individual driving the road vehicle to make speed and direction adjustments in reaction to unforeseen conditions that are not part of the default path or readily identifiable by fully-autonomous driving solutions. As a result, safety is enhanced while enabling the physically-disabled and/or other individuals to operate the road vehicle with an improved user experience.

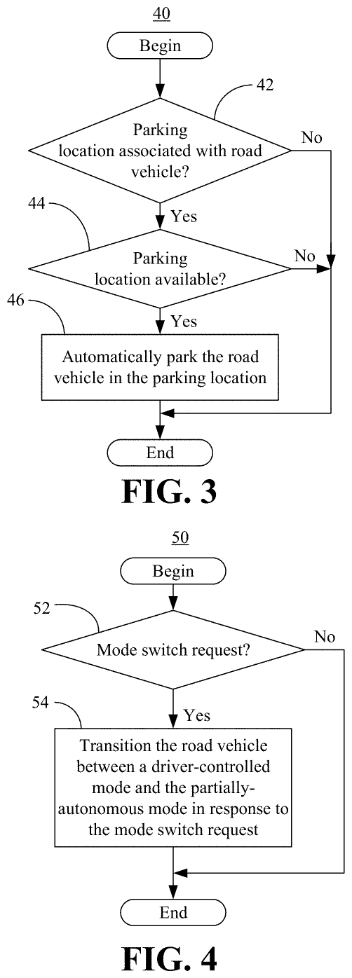

FIG. 3 shows a method 40 of parking a partially-autonomous road vehicle. The method 40, which may be implemented in software, configurable logic, fixed-functionality hardware logic, etc., or any combination thereof, may be incorporated into the method 20 (FIG. 2) as, for example, part of adherence to the default path or a deviation from the default path. In the illustrated example, a determination is made at block 42 as to whether a parking location is associated with the road vehicle. In an embodiment, block 42 includes searching database information to determine whether the destination includes handicapped parking spaces. If so, a determination may be made at block 44 as to whether the parking location is available (e.g., unoccupied). In one example, block 44 includes conducting object recognition on images and/or video of the parking location (e.g., captured by an external camera of the road vehicle and/or parking facility), conducting radar analysis, etc.

If the parking location is available, illustrated block 46 automatically parks the road vehicle in the parking location. Block 46 may use image, radar and/or lidar sensor information to steer the road vehicle into the parking location. If either there is no parking location associated with the road vehicle or the parking location is not available, the method 40 bypasses block 46 and terminates. The illustrated method 40 further enhances the user experience by automating more complex aspects of road vehicle operation (e.g., tight lateral and/or longitudinal control).

FIG. 4 shows a method 50 of selectively activating a partially-autonomous mode. The method 50, which may be implemented in software, configurable logic, fixed-functionality hardware logic, etc., or any combination thereof, may be used to selectively trigger a method such as, for example, the method 20 (FIG. 2), already discussed. A determination may be made at block 52 as to whether a mode switch request has been detected. In an embodiment, block 52 includes detecting the mode switch request via a single-extremity interface such as, for example, the foot pedals 10 (FIG. 1) and/or the arrow keys 12 (FIG. 1). If the mode switch request is detected, illustrated block 54 transitions the road vehicle between a driver-controlled mode and the partially-autonomous mode in response to the mode switch request. If the mode switch request is not detected, the method 50 may bypass block 54. The illustrated method 50 further enhances safety and the user experience by enabling non-disabled drivers to selectively assume full control over the road vehicle.

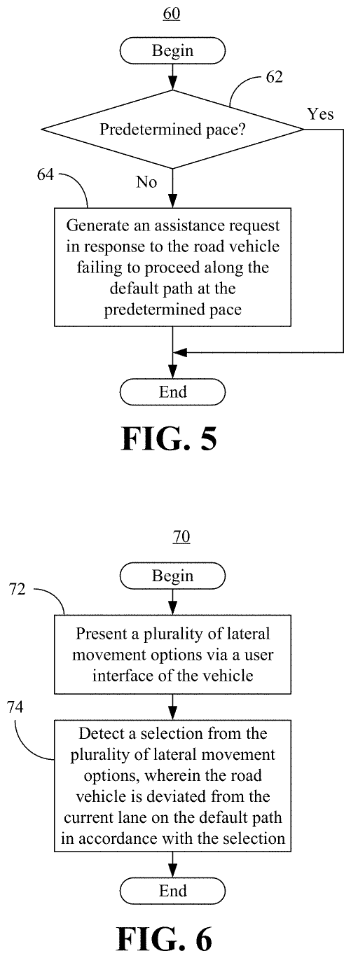

FIG. 5 shows a method 60 of managing the progress of a partially-autonomous road vehicle. The method 60, which may be implemented in software, configurable logic, fixed-functionality hardware logic, etc., or any combination thereof, may be incorporated into the method 20 (FIG. 2) as, for example, part of adherence to the default path or a deviation from the default path. A determination may be made at block 62 as to whether the road vehicle has proceeded along the default path at a predetermined pace. In an embodiment, block 62 includes automatically comparing one or more current timestamps to estimated time of arrival (ETA) data associated with various locations along the default path.

If the road vehicle has not proceeded at the predetermined pace, the driver may have encountered a navigation and/or control problem and illustrated block 64 generates an assistance request in response to the road vehicle failing to proceed along the default path at the predetermined pace. Block 64 might include sending a wireless and/or audible message to a caretaker, remote operator and/or bystander requesting assistance. For example, the assistance request might be coupled with permission of the bystander to enter the road vehicle, issue a mode switch request (e.g., transitioning the vehicle to the driver-controlled mode), and operate the road vehicle. Indeed, the primary driver may operate the road vehicle from the passenger seat to facilitate such bystander assistance from the driver seat. In such a case, during operation by the primary driver, the longitudinal and/or lateral activation events would be detected with respect to the passenger seat of the road vehicle. If it is determined at block 62 that the road vehicle has maintained the predetermined pace, the illustrated method 60 bypasses block 64 and terminates.

FIG. 6 shows a method 70 of deviating a road vehicle from a default path. The method 70, which may be implemented in software, configurable logic, fixed-functionality hardware logic, etc., or any combination thereof, may be incorporated into block 28 (FIG. 2) of the method 20 (FIG. 2), already discussed. Illustrated block 72 provides for presenting a plurality of lateral movement options (e.g., lane changes, turns, a discrete collection of smooth lateral deviations while proceeding in the current “ego” lane) via a user interface (e.g., speaker, display) of the road vehicle. Additionally, block 74 detects a selection from the plurality of lateral movement options, wherein the road vehicle is deviated from the current lane on the default path in accordance with the selection. The illustrated method 70 therefore further enhances the user experience and safety by providing the driver with a discrete set of choices.

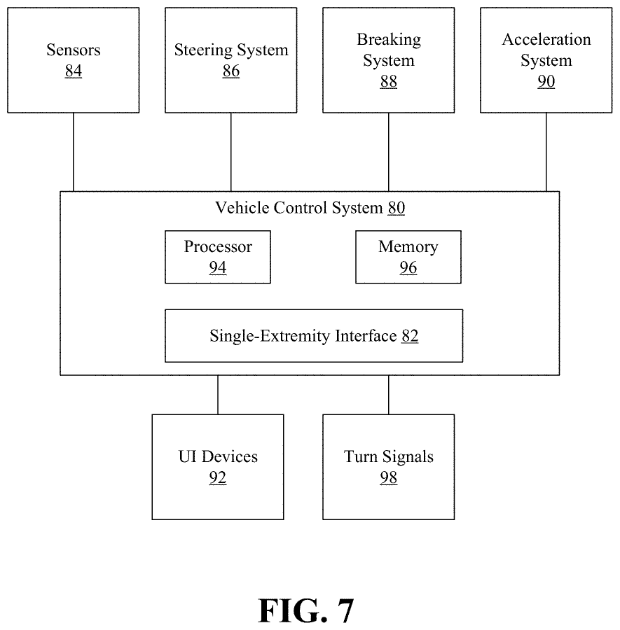

Turning now to FIG. 7, a vehicle control system 80 is shown in which a partially-autonomous road vehicle may be controlled via a single-extremity interface 82 such as, for example, the foot pedals 10 (FIG. 1) or the arrow keys 12 (FIG. 1), already discussed. In the illustrated example, the control system 80 is coupled to a plurality of sensors 84 (e.g., speed sensors to determine the speed of the road vehicle, image sensors, motion sensors, compass sensors, etc.), a steering system 86, a breaking system 88, an acceleration system 90 (e.g., throttle control), one or more user interface (UI) devices 92 (e.g., speaker, microphone), and one or more turn signals 98.

In an embodiment, the control system 80 includes a processor 94 (e.g., embedded controller) and a memory 96 (e.g., non-volatile memory/NVM and/or volatile memory) coupled to the processor 94. The memory 96 may include a stored default path and a stored set of instructions, which when executed by the processor 94, cause the control system 80 to conduct one or more aspects of the method 20 (FIG. 2), the method 40 (FIG. 3), the method 50 (FIG. 4), the method 60 (FIG. 5) and/or the method 70 (FIG. 6), already discussed. Thus, execution of the instructions by the processor 94 causes the control system 80 to control the road vehicle in a partially-autonomous mode along the default path and change the speed of the road vehicle in response to a first actuation event detected via the single-extremity interface 82.

Execution of the instructions by the processor 94 may also cause the vehicle control system 80 to deviate the road vehicle from a current lane on the default path in response to a second actuation event if a distance condition is satisfied with respect to a future lane change and/or a future turn on the default path. The second actuation event may also be detected via the single-extremity interface 82. Accordingly, both the first actuation event and the second actuation event may be associated with a single-extremity user operation. More particularly, the single-extremity user operation might be a single-foot operation with respect to one or more foot pedals, a single-finger operation with respect to a keyboard, and so forth.

In one example, execution of the instructions by the processor 94 causes the control system 80 to park the road vehicle in a parking location if the parking location is associated with the road vehicle and the parking location is available. Moreover, execution of the instructions by the processor 94 may cause the control system 80 to transition the road vehicle between a driver-controlled mode and the partially-autonomous mode in response to a mode switch request. In an embodiment, execution of the instructions by the processor 94 also causes the control system 80 to generate an assistance request in response to the road vehicle failing to proceed along the default path at a predetermined pace. Additionally, execution of the instructions by the processor 94 may cause the control system 80 to automatically activate the turn signal(s) 98 of the road vehicle in accordance with the default path and/or a deviation from the default path.

In addition, execution of the instructions by the processor 94 might cause the control system 80 to detect the first actuation event and/or the second actuation event with respect to a passenger seat of the road vehicle. Such an approach enables other individuals to assist the primary individual from the driver seat as appropriate. In an embodiment, execution of the instructions by the processor 94 causes the control system 80 to present a plurality of lateral movement options via the UI devices 92 and detect a selection from the plurality of lateral movement options, wherein the road vehicle is deviated from the current lane on the default path in accordance with the selection.

The illustrated control system 80 therefore enables the individual driving the road vehicle to make speed and direction adjustments in reaction to unforeseen conditions that are not part of the default path or readily identifiable by fully-autonomous driving solutions. As a result, safety is enhanced while enabling the physically-disabled individual to operate the road vehicle with an improved user experience. As already noted, the illustrated single-extremity interface 82 may also be used by non-disabled individuals (e.g., drivers wishing to take a break from fully-manual operation of the road vehicle).

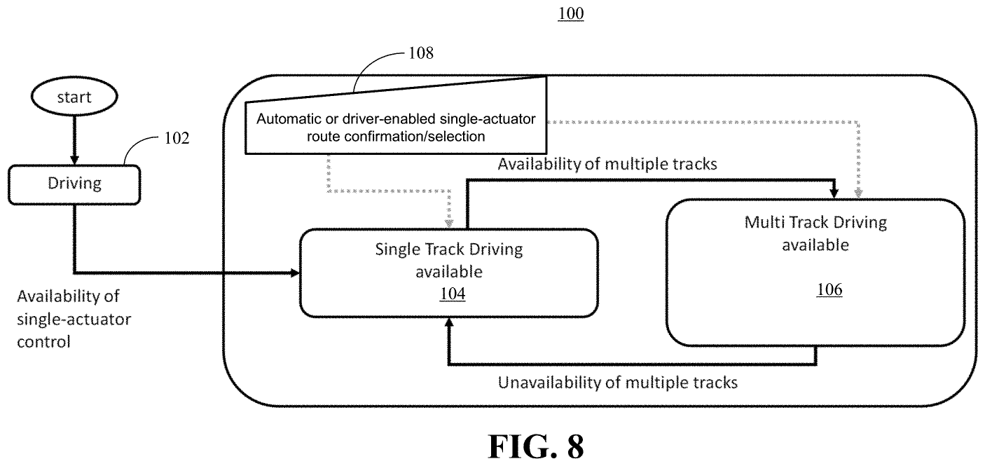

FIG. 8 shows a state diagram 100 of an example of a vehicle control system such as, for example, the vehicle control system 80 (FIG. 7), already discussed. In the illustrated example, the control system begins in a driving state 102. When it is determined (e.g., based on the existence of a default path) that a single-actuator/extremity control is available, the system transitions to a single track (e.g., lane) driving state 104 in which the driver only actuates longitudinal control. When multiple tracks/lanes are available (e.g., based on mandatory lane change data), the system transitions into a multi-track driving state 106 in which the driver may choose to control the longitudinal or lateral direction. When multiple lanes are not available (e.g., a distance condition is not satisfied), the system transitions back to the single track driving state 104. The illustrated state diagram 100 also provides for a default state confirmation/selection 108 based on the time of day, frequency of use, current path, and so forth.

The technology described herein therefore simplifies human input via automation and enables humans to remain “in the loop” during automated driving operations. Such an approach may address “overtrust” issues by involving driver attention and actuation.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A vehicle control system comprising:
a sensor to determine a speed of a road vehicle;
a processor coupled to the sensor; and
a memory coupled to the processor, the memory comprising a stored default path and a stored set of instructions, which when executed by the processor, cause the vehicle control system to:
control the road vehicle in a partially-autonomous mode along the default path,
change the speed of the road vehicle in response to a first actuation event, and
deviate the road vehicle from a current lane on the default path in response to a second actuation event if a distance condition is satisfied with respect to one or more of a future lane change or a future turn on the default path, wherein the first actuation event and the second actuation event are associated with a single-extremity user operation.

2. The vehicle control system of claim 1, further including one or more foot pedals, wherein the single-extremity user operation is a single-foot operation with respect to the one or more foot pedals.

3. The vehicle control system of claim 1, further including a keyboard, wherein the single-extremity user operation is a single-finger operation with respect to the keyboard.

4. The vehicle control system of claim 1, wherein the instructions, when executed, further cause the computing system to park the road vehicle in a parking location if the parking location is associated with the road vehicle and the parking location is available.

5. The vehicle control system of claim 1, wherein the instructions, when executed, further cause the computing system to transition the road vehicle between a driver-controlled mode and the partially-autonomous mode in response to a mode switch request.

6. The vehicle control system of claim 1, wherein the instructions, when executed, further cause the computing system to generate an assistance request in response to the road vehicle failing to proceed along the default path at a predetermined pace.

7. The vehicle control system of claim 1, wherein the instructions, when executed, further cause the computing system to automatically activate one or more turn signals of the road vehicle in accordance with the default path.

8. The vehicle control system of claim 1, wherein the instructions, when executed, further cause the computing system to detect one or more of the first actuation event or the second actuation event with respect to a passenger seat of the road vehicle.

9. At least one computer readable storage medium comprising a set of instructions, which when executed by a computing system, cause the computing system to:
control a road vehicle in a partially-autonomous mode along a default path;
change a speed of the road vehicle in response to a first actuation event; and
deviate the road vehicle from a current lane on the default path in response to a second actuation event if a distance condition is satisfied with respect to one or more of a future lane change or a future turn on the default path, wherein the first actuation event and the second actuation event are associated with a single-extremity user operation.

10. The at least one computer readable storage medium of claim 10, wherein the single-extremity user operation is a single-foot operation with respect to one or more foot pedals.

11. The at least one computer readable storage medium of claim 10, wherein the single-extremity user operation is a single-finger operation with respect to a keyboard.

12. The at least one computer readable storage medium of claim 10, wherein the instructions, when executed, further cause the computing system to park the road vehicle in a parking location if the parking location is associated with the road vehicle and the parking location is available.

13. The at least one computer readable storage medium of claim 10, wherein the instructions, when executed, further cause the computing system to transition the road vehicle between a driver-controlled mode and the partially-autonomous mode in response to a mode switch request.

14. The at least one computer readable storage medium of claim 10, wherein the instructions, when executed, further cause the computing system to generate an assistance request in response to the road vehicle failing to proceed along the default path at a predetermined pace.

15. The at least one computer readable storage medium of claim 10, wherein the instructions, when executed, further cause the computing system to automatically activate one or more turn signals of the road vehicle in accordance with the default path.

16. The at least one computer readable storage medium of claim 10, wherein the instructions, when executed, further cause the computing system to detect one or more of the first actuation event or the second actuation event with respect to a passenger seat of the road vehicle.

17. The at least one computer readable storage medium of claim 10, wherein the instructions, when executed, further cause the computing system to:
present a plurality of lateral movement options via a user interface of the road vehicle; and
detect a selection from the plurality of lateral movement options, wherein the road vehicle is deviated from the current lane on the default path in accordance with the selection.

18. A method of operating a vehicle control system comprising:
controlling a road vehicle in a partially-autonomous mode along a default path;
changing a speed of the road vehicle in response to a first actuation event; and
automatically deviating the road vehicle from a current lane on the default path in response to a second actuation event if a distance condition is satisfied with respect to one or more of a future lane change or a future turn on the default path, wherein the first actuation event and the second actuation event are associated with a single-extremity user operation.

19. The method of claim 18, wherein the single-extremity user operation is a single-foot operation with respect to one or more foot pedals.

20. The method of claim 18, wherein the single-extremity user operation is a single-finger operation with respect to a keyboard.
